(19) United States
(12) Patent Application Publication
(10) Pub. No.: US 2018/0361413 A1
(43) Pub. Date: Dec. 20, 2018

(54) VACUUM BOTTLE WITH ROTARY TELESCOPIC PRESSING HEAD

(71) Applicant: ZHEJIANG JINSHENG NEW MATERIALS CO., LTD., Shaoxing (CN)

(72) Inventor: RongTao RUAN, Shangyu (CN)

(21) Appl. No.: 16/005,972

(22) Filed: Jun. 12, 2018

(30) Foreign Application Priority Data
Jun. 14, 2017 (CN) 201720689852.5

(51) Int. Cl. B05B 11/00; A45D 34/00

(52) U.S. Cl. CPC B05B 11/3047; A45D 34/00; B05B 11/306

(57) ABSTRACT

A vacuum bottle with a rotary telescopic pressing head comprising a bottle body, wherein an inner container is disposed in the bottle body, a piston is disposed in the inner container, a pump sleeve is disposed on the inner container, and an eccentric hole is formed in the pump sleeve; a pressing pump is disposed in the eccentric hole, and a rotary sleeve is disposed on the pump sleeve; a rotary sleeve through-hole is formed in the rotary sleeve, and the pressing pump is located in the rotary sleeve through-hole; an inner pressing head is disposed on the pressing pump, and the inner pressing head can rotate horizontally; an outer pressing head is disposed on the inner pressing head; an inner cover is disposed on the rotary sleeve, and an outer cover is sleeved on the inner cover.

### TECHNICAL FIELD OF THE INVENTION

The present invention relates to the technical field of vacuum bottles, and more particularly, to a vacuum bottle with a rotary telescopic pressing head.

### BACKGROUND OF THE INVENTION

In the prior art, liquid skin-care products (e.g., skin emulsion) sold on the market are mostly stored in bottles. A traditional emulsion bottle usually comprises an emulsion pump and a bottle body. Its operating principle is that the volume of the bottle body can be periodically increased or reduced through pressing the spray-head. As the pressure is increased, the emulsion in the bottle can be easily pumped out. Namely, after the spray-head of the emulsion pump is pressed, the emulsion is forced to flow out from the bottle. However, the spray-head can be carelessly touched in daily life, causing the emulsion waste, which pollutes the environment.

### SUMMARY OF THE INVENTION

The purpose of the present invention is to solve the shortcomings in the prior art by providing a vacuum bottle with a rotary telescopic pressing head.

To achieve the above purpose, the present invention adopts the following technical solution:

A vacuum bottle with a rotary telescopic pressing head comprising a bottle body, wherein an inner container is disposed in the bottle body, a piston is disposed in the inner container, a pump sleeve is disposed on the inner container, and an eccentric hole is formed in the pump sleeve; a pressing pump is disposed in the eccentric hole, and a rotary sleeve is disposed on the pump sleeve; a rotary sleeve through-hole is formed in the rotary sleeve, and the pressing pump is located in the rotary sleeve through-hole; an inner pressing head is disposed on the pressing pump, and the inner pressing head can horizontally rotate; an outer pressing head is disposed on the inner pressing head; an inner cover is disposed on the rotary sleeve, and an outer cover is sleeved on the inner cover; the outer cover can horizontally rotate, and a positioning strip is disposed on the rotary sleeve; when the inner pressing head rotates to retract into the outer cover, the top portion of the positioning strip is in contact with the inner pressing head.

In another aspect of the present invention, a sealing ring is disposed between the pump sleeve and the pressing pump.

In another aspect of the present invention, a rotation-stopping block is disposed on the outer cover.

In another aspect of the present invention, a convex ring is disposed on the inner cover, and a groove is formed in the outer cover. The convex ring is clamped in the groove.

In another aspect of the present invention, the piston is made from PE material. A first protruding ring and a second protruding ring are respectively disposed on the outer edge of the piston.

Compared with the prior art, the present invention has the following advantages:

Through rotating the outer cover, the pressing head can stretch and retract.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is a structural diagram of the present invention;

FIG. 2 is a structural diagram when the inner pressing head rotates to retract into the outer cover;

FIG. 3 is a structural diagram of the pump sleeve of the present invention;

FIG. 4 is a structural diagram of the rotary sleeve of the present invention;

FIG. 5 is an enlarged view of portion A in FIG. 1; and

FIG. 6 is an enlarged view of portion B in FIG. 1.

### MARKING INSTRUCTIONS OF THE DRAWINGS

1—Bottle Body, 2—Inner Container, 3—Piston, 4—Pump Sleeve, 5—Eccentric Hole, 6—Pressing Pump, 7—Rotary Sleeve, 8—Rotary Sleeve Through-hole, 9—Inner Pressing Head, 10—Out Pressing Head, 11—Inner Cover, 12—Outer Cover, 13—Positioning Strip, 14—Sealing Ring, 15—Rotation-stopping Block, 16—Convex Ring, 17—Groove, 18—The First Protruding Ring, 19—The Second Protruding Ring

### DETAILED DESCRIPTION OF THE INVENTION

Drawings and detailed embodiments are combined hereinafter to elaborate the technical principles of the present invention.

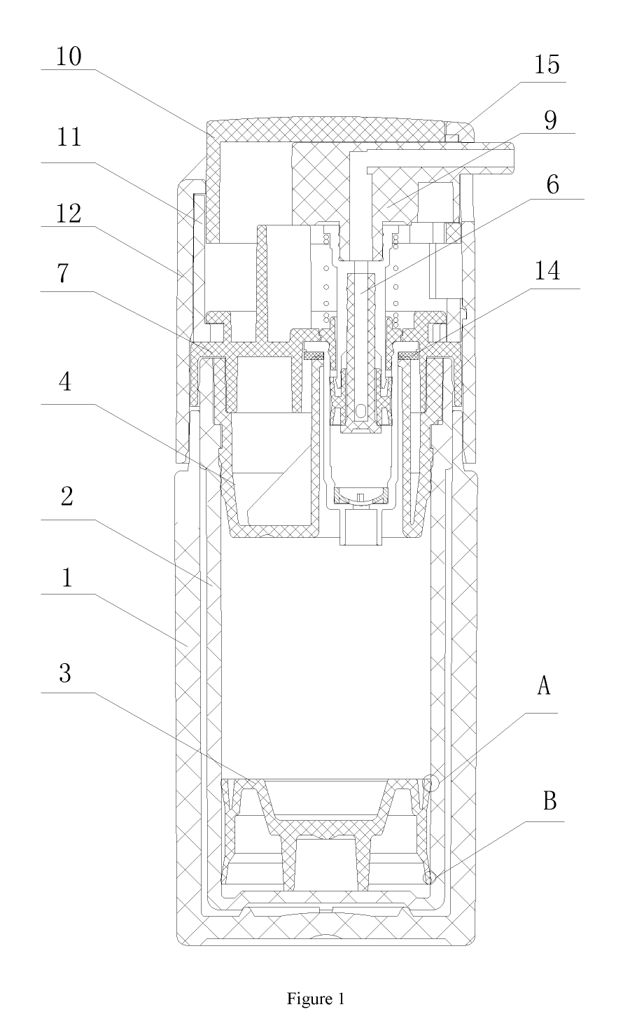

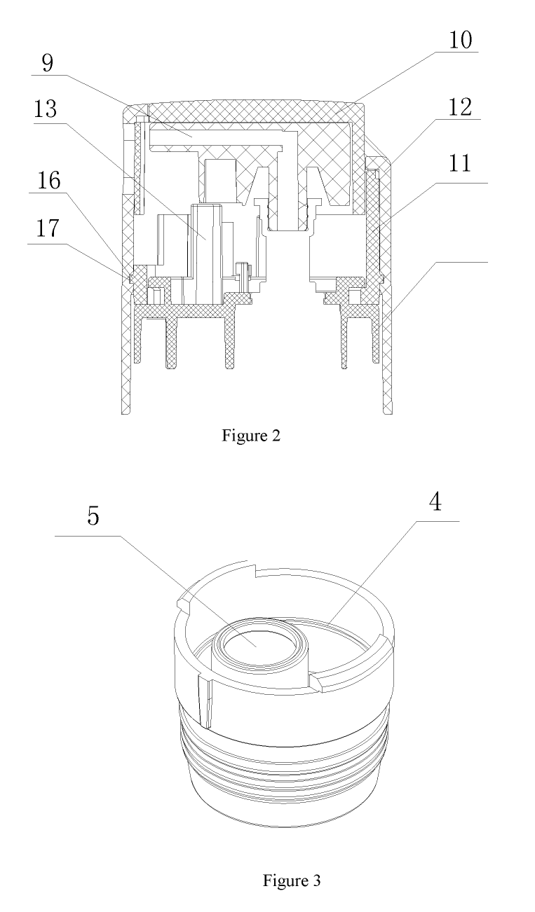

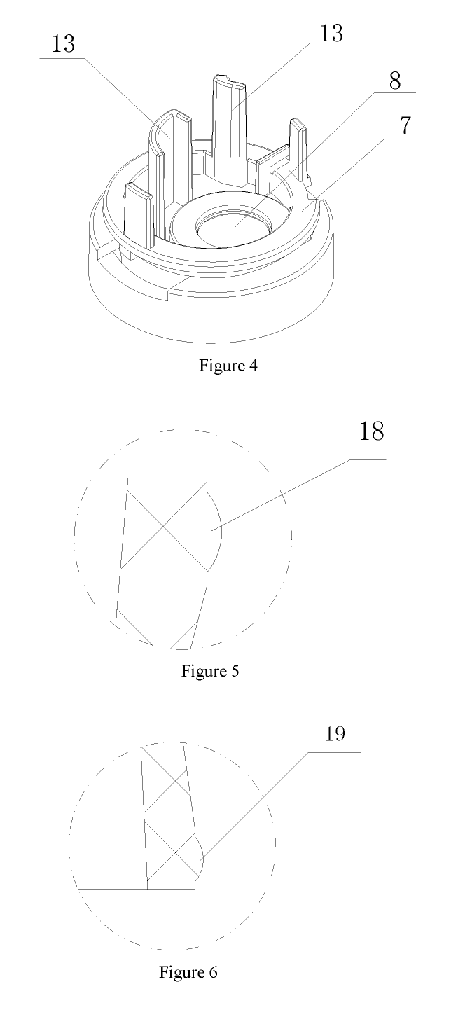

As shown in FIG. 1, the vacuum bottle with a rotary telescopic pressing head comprises a bottle body 1. An inner container 2 is disposed in the bottle body. Preferably, the inner container 2 is made from polypropylene. A piston 3 is disposed in the inner container 2, a pump sleeve 4 is disposed on the inner container 2, and an eccentric hole 5 is formed in the pump sleeve 4. A pressing pump 6 is disposed in the eccentric hole 5, and a rotary sleeve 7 is disposed on the pump sleeve 4. A rotary sleeve through-hole 8 is formed in the rotary sleeve 7, and the pressing pump 6 is located in the rotary sleeve through-hole 8. An inner pressing head 9 is disposed on the pressing pump 6, and the inner pressing head 9 can horizontally rotate. An outer pressing head 10 is disposed on the inner pressing head 9. An inner cover 11 is disposed on the rotary sleeve 7, and an outer cover 12 is sleeved on the inner cover 11. The outer cover 12 can horizontally rotate, and a positioning strip 13 is disposed on the rotary sleeve 7. When the inner pressing head 9 rotates to retract into the outer cover 12, the top portion of the positioning strip 13 contacts the inner pressing head 9.

Additionally, a sealing ring 14 is disposed between the pump sleeve 4 and the pressing pump 6. Thus, a higher sealing performance of the vacuum bottle with a rotary telescopic pressing head of the present invention can be achieved.

A rotation-stopping block 15 is disposed on the outer cover 12. The rotation-stopping block 15 is capable of preventing the inner pressing head 9 from rotating within the outer cover 12 when the inner pressing head 9 rotates to retract into the outer cover 12. The rotation-stopping block 15 is made from PE material. Thus, chemical reaction between residual emulsion on the pressing head and the outer cover can be prevented.

A convex ring 16 is disposed on the inner cover 11, and a groove 17 is formed in the outer cover 12. The convex ring 16 is clamped in the groove 17. This design enables the outer cover 12 to flexibly rotate on the inner cover 11.

The piston 3 is made from PE material. A first protruding ring 18 and a second protruding ring 19 are respectively disposed on the outer edge of the piston 3. Thus, the sealing performance of the piston can be enhanced.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A vacuum bottle with a rotary telescopic pressing head, comprising:
a bottle body, wherein an inner container is disposed in the bottle body, a piston is disposed in the inner container, a pump sleeve is disposed on the inner container, and an eccentric hole is formed in the pump sleeve, wherein a pressing pump is disposed in the eccentric hole, and a rotary sleeve is disposed on the pump sleeve, wherein a rotary sleeve through-hole is formed in the rotary sleeve, and the pressing pump is located in the rotary sleeve through-hole, wherein an inner pressing head is disposed on the pressing pump, and the inner pressing head can horizontally rotate, wherein an outer pressing head is disposed on the inner pressing head, wherein an inner cover is disposed on the rotary sleeve, and an outer cover is sleeved on the inner cover, wherein the outer cover can horizontally rotate, and a positioning strip is disposed on the rotary sleeve, wherein when the inner pressing head rotates to retract into the outer cover, the top portion of the positioning strip is in contact with the inner pressing head.

2. The vacuum bottle with a rotary telescopic pressing head of claim 1, wherein a sealing ring is disposed between the pump sleeve and the pressing pump.

3. The vacuum bottle with a rotary telescopic pressing head of claim 1, wherein a rotation-stopping block is disposed on the outer cover.

4. The vacuum bottle with a rotary telescopic pressing head of claim 1, wherein a convex ring is disposed on the inner cover and a groove is formed in the outer cover, wherein the convex ring is clamped in the groove.

5. The vacuum bottle with a rotary telescopic pressing head of claim 1, wherein the piston is made from PE material, wherein a first protruding ring and a second protruding ring are respectively disposed on the outer edge of the piston.
